(19) United States
(12) Patent Application Publication
(10) Pub. No.: US 2007/0231104 A1
(43) Pub. Date: Oct. 4, 2007

(54) Track fixture

(75) Inventor: Jui-Lin Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/396,073

(22) Filed: Mar. 30, 2006

(51) Int. Cl. F16B 39/00

(52) U.S. Cl. 411/166

(57) ABSTRACT

A track fixture is disclosed for engaging a track with a rack of a server. The rack has a first through hole. The track fixture includes a track bearer for engaging with the track, the track bearer including a fixing portion having a second through hole; a fixing slice including a positioning hole corresponding to the second through hole; a positioning component including a positioning portion having a shape matched with a shape of the positioning hole, for passing through the first through hole and the second through hole and being positioned in the positioning hole; and an engaging component for engaging with the positioning component, so as to fix the track bearer to the rack.

### BACKGROUND OF THE INVENTION

1. Field of the Invention

This invention relates to fixtures, and more particularly, to a track fixture applicable to a rack of a server.

2. Description of Related Art

In modern society, computers such as a server are becoming one of the most popular electronic devices. The server takes the charge of varieties of information services. In general, the server, if in use, is accommodated in a rack. A variety of racks are brought to the market accordingly. However, these racks are not compatible to one another. Therefore, the server needs a track fixture to fix itself to the rack.

The track fixture of the prior art fixes a track to the server. The track is then installed on a track bearer, and assembled to the rack, which has a circular or rectangular hole. In order to install the server on the rack, a user has to select a track bearer having members corresponding to the circular or rectangular hole of the rack. Since such a track bearer is designed especially for the rack, the track bearer can not be applied to other racks.

U.S. application Ser. No. 10/968,510 discloses a method for mounting a slide assembly to a computer server rack including a rack column. A track bearer has a slide perpendicular surface. A rack having a worm is installed on one end of the slide perpendicular surface. A plurality of dual-diameter mounting pins are installed for engaging with the track bearer, so as to fix the track bearer to the rack.

The above method has to use two different types of members, that is a circular and a rectangular mounting pin, to fix the track bearer to the rack. Moreover, racks manufactured by different manufacturers are different, so a track bearer can not be fixed to a rack unless the track bearer is exactly compatible to the rack.

### SUMMARY OF THE INVENTION

In views of the above-mentioned problems of the prior art, it is a primary objective of the present invention to provide a track fixture for fixing a track to a rack having a circular or a rectangular hole.

It is another objective of the present invention to provide a track fixture having a simple structure and easy to be assembled.

To achieve the above-mentioned and other objectives, a track fixture is provided according to the present invention. The track fixture is used for engaging a track with a rack of a server. The rack has a first through hole. The track fixture includes a track bearer for engaging with the track, the track bearer having a fixing portion having a second through hole; a fixing slice having a positioning hole corresponding to the second through hole; a positioning component having a positioning portion having a shape matched with a shape of the positioning hole for passing through the first through hole and the second through hole and positioning on the positioning hole; and an engaging component for engaging with the positioning component, so as to fix the track bearer to the rack.

The positioning hole has a non-circular cross section. Preferably, the non-circular cross section is in the shape of one selected from the group consisting of a character D, a polygon and a rectangle.

The positioning portion of the positioning component has a non-circular cross section. Preferably, the non-circular cross section of the positioning portion is in the shape of one selected from the group consisting of a character D, a polygon and a rectangle. The engaging component is a nut.

Having the circular and rectangular positioning poles, the track fixture of the present invention can work with the circular and rectangular holes of different racks. Moreover, the track fixture has a simple structure, and is easy to be assembled and replaced.

### BRIEF DESCRIPTION OF DRAWINGS

The invention can be more fully understood by reading the following detailed description of the preferred embodiments, with reference made to the accompanying drawings, wherein:

FIG. 1 is an explosive view of a track fixture of the preferred embodiment according to the present invention;

FIG. 2 is an assembly view of the track fixture shown in FIG. 1; and

FIGS. 3A and 3B are two assembly views of the track fixture shown in FIG. 1 and a rack of the server.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

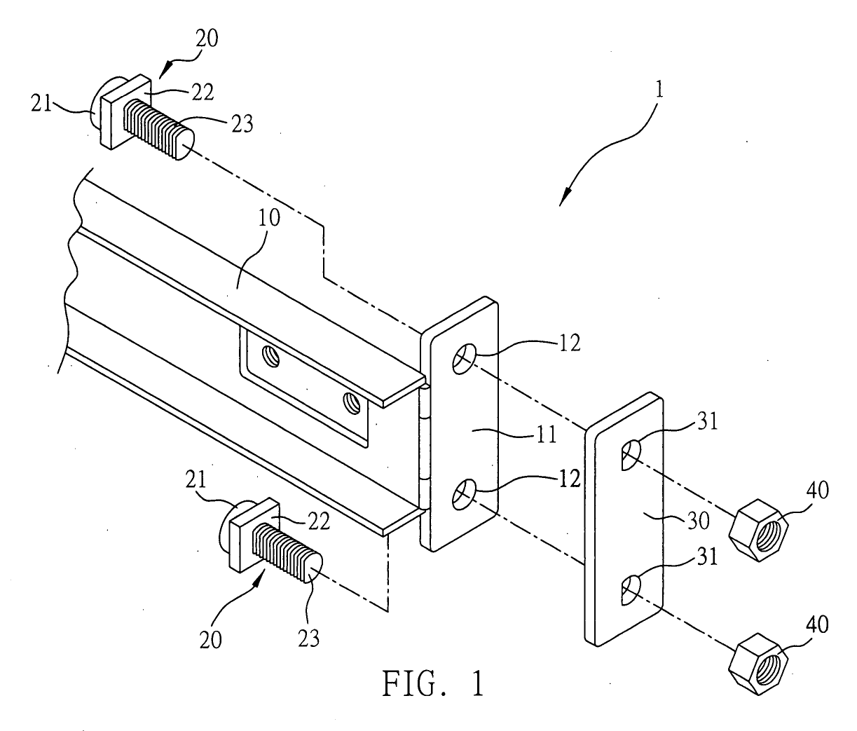

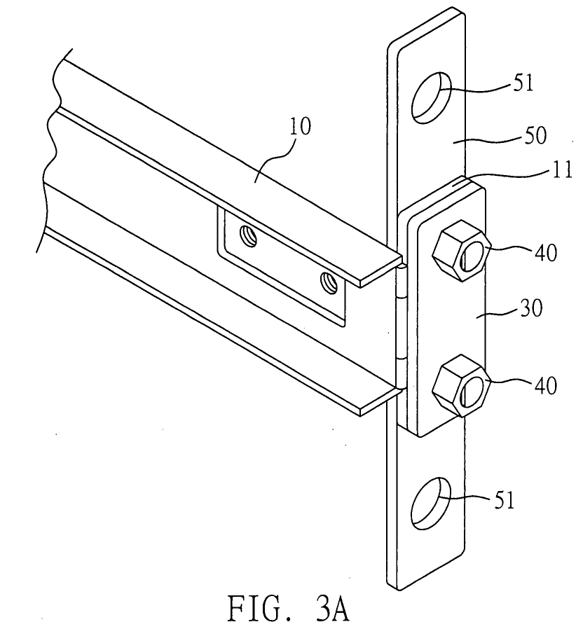

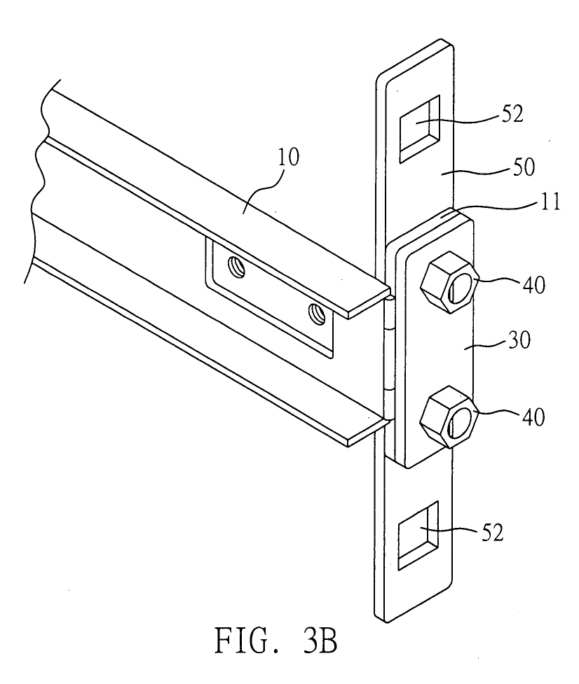

FIG. 1 is an explosive view of a track fixture 1 of the preferred embodiment according to the present invention. The track fixture 1 is applicable to a rack 50 (shown in FIGS. 3A and 3B) of a server. The rack 50 shown in FIG. 3A comprises at least a circular first through hole 51, and the rack 50 shown in FIG. 3B comprises at least a rectangular first through hole 52. The track fixture 1 comprises a track bearer 10, a positioning component 20, a fixing slice 30 and an engaging component 40.

The track bearer 10 is installed for bearing tracks (not shown) along which the server slides. The track bearer 10 comprises a fixing portion 11 perpendicular to the track bearer 10. The fixing portion 11 comprises at least a second through hole 12. The positioning component 20 is allowed to pass through the first through hole 51(52) and the second through hole 12, and locked into the engaging component 40. The positioning component 20 comprises a circular positioning pole 21, a rectangular positioning pole 22 and a positioning portion 23 for passing itself through the second through hole 12 of fixing portion 11, so as to lock the positioning component 20 into the fixing portion 11.

The circular positioning pole 21 has a radius smaller than that of the rectangular positioning pole 22. The positioning portion 23 of the positioning component 20 is a screw pole having a D-shaped cross section. Note that the positioning poles 21 and 22 and the cross section of the positioning portion 23 of the positioning component 20 can be in any other shapes.

The fixing slice 30 comprises at least a positioning hole 31 for restricting the positioning portion 23 of the positioning component 20 from rotating if the positioning portion 23 is in the positioning hole 31. Accordingly, the positioning hole 31 of the fixing slice 30 has a cross section matched with that of the positioning portion 23 of the positioning component 20, and is in the D-shape according to the preferred embodiment.

The engaging component 40 is used to locked with the positioning portion 23 of the positioning component 20 after the positioning portion 23 of the positioning component 20 has passed through the second through hole 12 of the fixing portion 11. According to the preferred embodiment, the engaging component 40 is a nut.

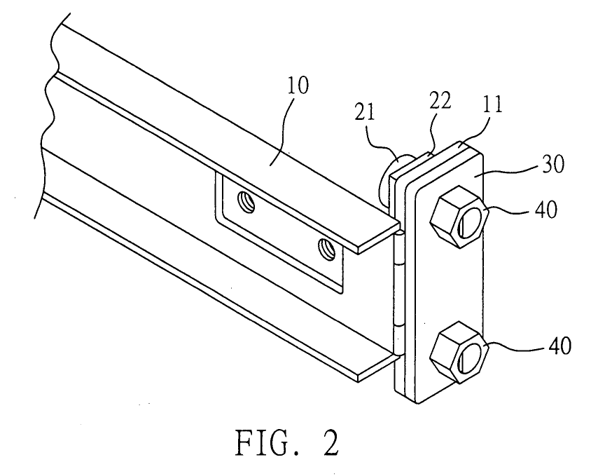

FIG. 2 is an assembly view of the track fixture 1. The positioning component 20 can be locked to the fixing portion 11 of the track bearer 10 by first passing the positioning portion 23 of the positioning component 20 through the second through hole 12 of the track bearer 10 and the D-shaped positioning hole 31 of the fixing slice 30 subsequently to fixing the positioning component 20 to the positioning hole 31, and then engaging the engaging component 40 with the positioning portion 23.

FIG. 3A is an assembly view of the track fixture 1 and the rack 50 of the server. The same reference symbols denote the portions having the same functions as in FIG. 1, and a detailed description thereof will be omitted for clarity.

The circular first through hole 51 has a radius slightly larger than the cross section of the positioning portion 23 of the positioning component 20. Therefore, when the track fixture 1 is positioning on the rack 50 of the server, the track fixture 1 can be fixed to the rack 50 of the server by passing the positioning portion 23 of the positioning component 20 through the first through hole 51 and the second through hole 12 subsequently to position the positioning portion 23 on positioning hole 31 and engage positioning portion 23 with engaging component 40.

FIG. 3B is another assembly view of the track fixture 1 and the rack 50 of the server. The same reference symbols denote the portions having the same functions as in FIG. 1, and a detailed description thereof will be omitted for clarity.

The rack 50 shown in FIG. 3B has the rectangular first through hole 52. The first through hole 52 also has a radius slightly larger than the cross section of the positioning portion 23 of the positioning component 20. Therefore, when the track fixture 1 is positioning on the rack 50 of the server, the track fixture 1 can be fixed to the rack 50 of the server by passing the positioning portion 23 of the positioning component 20 through the first through hole 51 and the second through hole 12 subsequently to position the positioning portion 23 on positioning hole 31 and engage positioning portion 23 with engaging component 40.

Having the circular and rectangular positioning poles, the track fixture of the present invention can work with the circular and rectangular holes of different rack. Moreover, the track fixture has a simple structure, and is easy to be assembled and replaced.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A track fixture for engaging a track with a rack of a server, the rack having a first through hole, the track fixture comprising:
a track bearer for being engaged with the track, the track bearer comprising a fixing portion having a second through hole;
a fixing slice comprising a positioning hole corresponding to the second through hole;
a positioning component comprising a positioning portion having a shape matched with a shape of the positioning hole, for passing through the first through hole and the second through hole and being positioned in the positioning hole; and
an engaging component for being engaged with the positioning component, so as to fix the track bearer to the rack.

2. The track fixture of claim 1, wherein the positioning hole has a non-circular cross section.

3. The track fixture of claim 2, wherein the non-circular cross section has a shape of one selected from the group consisting of a D shape, a polygon and a rectangle.

4. The track fixture of claim 1, wherein the first through hole of the rack is a circular hole or a rectangular hole.

5. The track fixture of claim 1, wherein the positioning portion of the positioning component has a non-circular cross section.

6. The track fixture of claim 5, wherein the non-circular cross section of the positioning portion has a shape of one selected from the group consisting of a D shape, a polygon and a rectangle.

7. The track fixture of claim 1, wherein the engaging component is a nut.
